(19) United States
(12) Patent Application Publication
(10) Pub. No.: US 2006/0077779 A1
(43) Pub. Date: Apr. 13, 2006

(54) Optical pickup device with elastic member

(75) Inventor: Chih-Sheng Wei, Taoyuan (TW)

Correspondence Address: TROXELL LAW OFFICE PLLC;SUITE 1404, 5205 LEESBURG PIKE, FALLS CHURCH, VA, 22041, US

(73) Assignee: BENQ Corporation

(21) Appl. No.: 11/068,812

(22) Filed: Mar. 2, 2005

(30) Foreign Application Priority Data
Sep. 3, 2004 (TW) 93106106

(51) Int. Cl. G11B 7/00

(52) U.S. Cl. 369/44.14; 369/44.15

(57) ABSTRACT

An optical pickup device with elastic member, the device comprises a driver, a gear, a rack, an optical head, a guide bar and an elastic member. The gear associated with the driver is rotated by it. The rack, whose back has at least a first fixed support, meshes and interlocks with the gear. One end of the optical head has at least a second fixed support with which the first fixed support connects through the guide bar so the rack and the optical head can interlock each other. The elastic member of the invention located on the optical head shores against the rack to provide a vertical elasticity and a parallel elasticity to the rack axle and reduce the back clearance between the gear and the rack, and the clearance between the rack and the optical head.

### FIELD OF THE INVENTION

The present inventions relate to an optical pickup device with elastic member, and more particularly, to an optical pickup device with elastic member capable of providing vertical and parallel pre-pressing elasticity.

### BACKGROUND OF THE INVENTION

The optical pickup device is a read head for an optical drive that uses a laser to discern pits and lands in ROM or R (recordable) media, and amorphous or crystalline states in RW (rewriteable) media. From the patterns thus read by the optical pickup device, the drive can interpret bits of data.

Optical drives are high-precision products in the high-tech industry. Taking a DVD player for example, over 4.7G data is stored in a spiral data track with 6 kilometers in length on a high-speed rotating optical disk. Because the track gage is only 0.74 μm in length in a high-speed rotation state, the laser has to locate the data precisely. Besides the good serve function of the optical head, a precise and stable driver is essential. Thus, whether the design of the elastic member of the optical pickup device is good or not is very important.

Referring to FIG. 1A, a schematic view of the conventional optical pickup device is shown. The conventional optical pickup device 10 is mainly composed of a servomotor 11, a spur gear 12, a rack 13, an optical head 14 and a splint 15. The spur gear 12 associated with the servomotor 11 is rotated by it; the rack 13 and the spur gear are in mesh; and the splint 15 is fixed on the optical head 14 and shores against the rack 13.

A side view of the first ear part of the conventional optical pickup device and a side view of the splint of the conventional optical pickup device are shown in FIG. 1B and FIG. 1C respectively. Referring to all FIGS. 1A, 1B and 1C, back of the conventional rack 13 has two first ear parts 132 and one end of the optical head 14 also has two second ear parts 142 which are located between these first ear parts 132, associated and interlocked with them through a guide bar 16. The guide bar 16 penetrates a center hole 134 of the first ear part 132 and the second ear part 142 to enable the rack 13 and the optical head 14 to slide along the guide bar 16. However, the conventional splint 15 is an L-sharp iron lamina with a protuberance 152 which shores against back of the rack 13 when the splint 15 is fixed to the optical head 14 in order to provide an upward-rotating force to the rack 13 and reduce the back clearance between the spur gear 12 and the rack 13.

To sum up, there are still some disadvantages of the conventional optical reading device:
a. Only the back clearance between the spur gear and the rack can be improved of conventional optical pickup device but the clearance between the rack and the optical head cannot be better.
b. The process of the conventional optical pickup device is relative difficult so that the formed splint is not reliable and the reliance of relative motion of the spur gear and rack is decreased.

### SUMMARY OF THE INVENTION

It is therefore an object of this present invention to provide an optical pickup device with elastic member, which can reduce the back clearance between the gear and the rack and the clearance between the rack and the optical head effectively. People skilled in the art can fully understand the other objects and advantages scaled by the claims after reading the specification of the invention.

To achieve the mentioned goal, the present invention provides an optical pickup device with elastic member, the device mainly comprising a driver, a gear, a rack, an optical head, a guide bar and an elastic member. The gear associated with the driver is rotated by it. The driver can be a servomotor and the gear can be a spur gear. The rack, whose back has at least a first fixed support, meshes and interlocks with the gear. One end of the optical head has at least a second fixed support with which the first fixed support connects through the guide bar so the rack and the optical head can interlock each other. The elastic member, which is a linear material made of stainless steel, spring steel, located on the optical head shores against the rack to provide a vertical elasticity and a parallel elasticity to the rack axle and reduce the back clearance between the gear and the rack, and the clearance between the rack and the optical head.

In the embodiment of this invention, the back of the rack has a protuberance. The elastic member has a first sideline and a second sideline wherein the first sideline shores against the back of the rack and the second sideline shores against the protuberance. The optical head with the second fixed support is associated with a plurality of protuberances which the first sideline and the second sideline of the elastic member shore against respectively through a locking screw wherein the first sideline and the second sideline are locked with the optical head. Moreover, the change of elasticity of the first sideline and the second sideline ranges between 10 g and 30 g which can reduce the back clearance between the gear and the rack, and the clearance between the rack and the optical head.

In the embodiment of this invention, the optical pickup device with elastic member is chosen from the group consisting of DVD-ROM drive, DVD-R drive, DVD-RW drive, CD-ROM drive, CD-R drive and CD-RW drive.

The elastic member applied to the invention is connected to the rack by simple fabrication to provide a vertical elasticity and a parallel elasticity to the rack axle and reduce the clearance between connecting components effectively.

### BRIEF DESCRIPTION OF THE DRAWINGS

FIG. 1A is a schematic view of the conventional optical reading device.

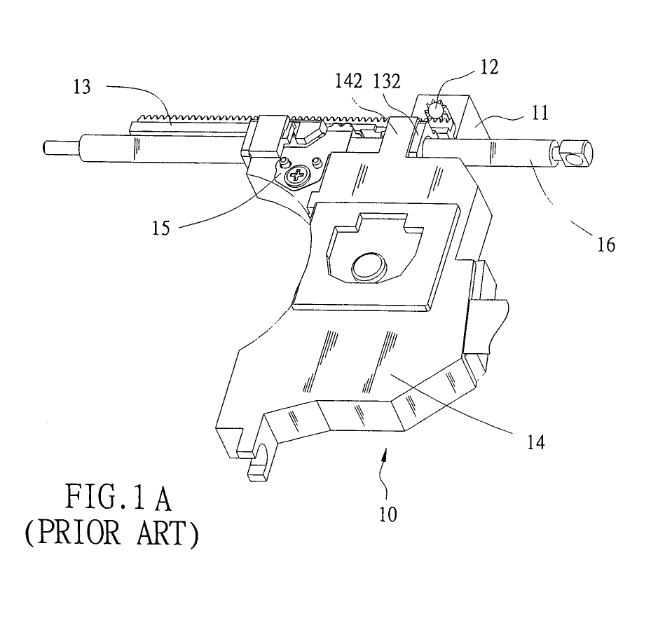

FIG. 1B is a side view of the first ear part of the conventional optical reading device.

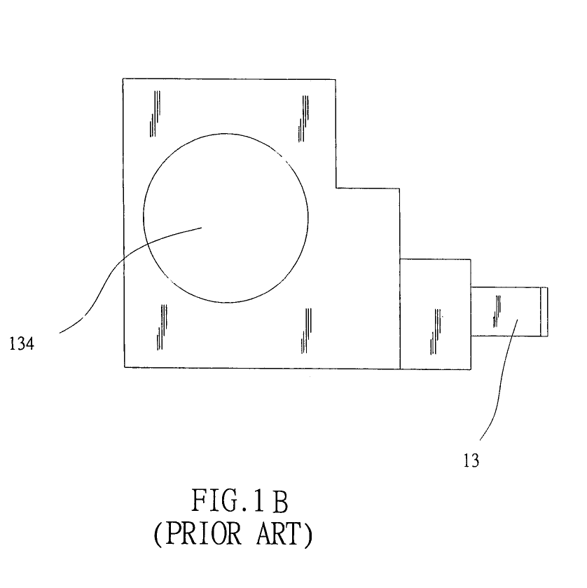

FIG. 1C is a side view of the splint of the conventional optical reading device.

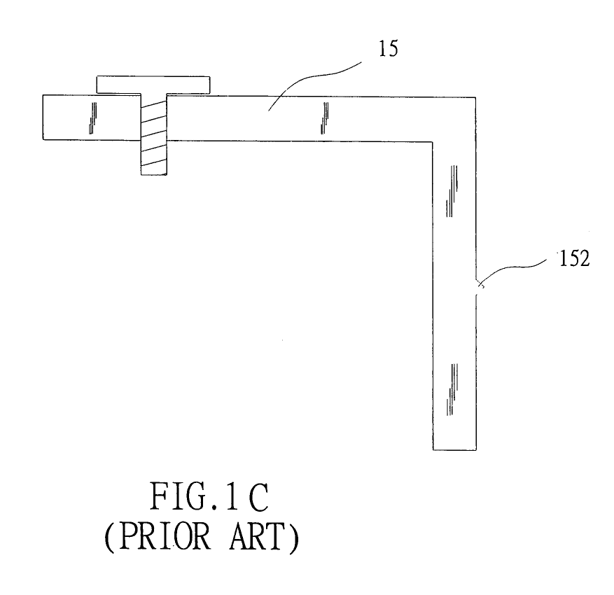

FIG. 2A is a schematic view of the preferred embodiment of an optical pickup device with elastic member of the present invention in use.

FIG. 2B is a side view of the preferred embodiment of a first fixed support of the optical pickup device with elastic member of the present invention in use.

FIG. 2C is a schematic view of the preferred embodiment of an elastic member of the optical pickup device with elastic member of the present invention in use.

### DESCRIPTION OF THE PREFERRED EMBODIMENT

The above and other objects and the advantages and features of the present inventions will be more apparent from the detailed description of preferred embodiments, taken in conjunction with the drawings.

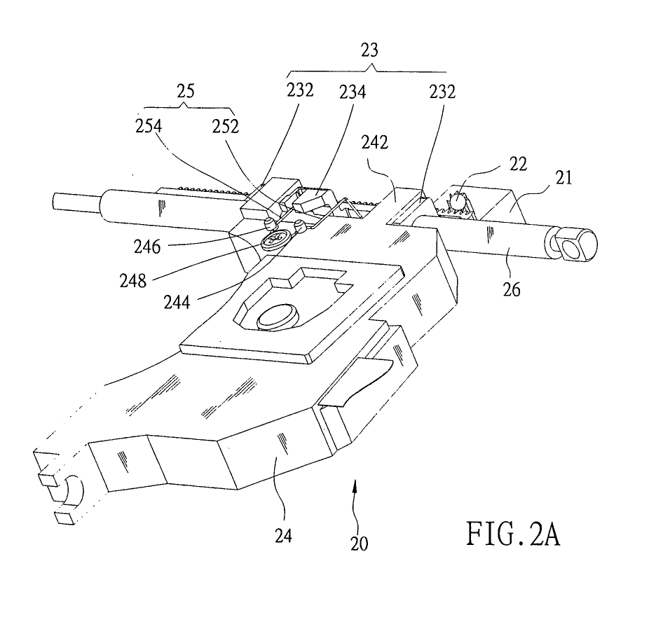

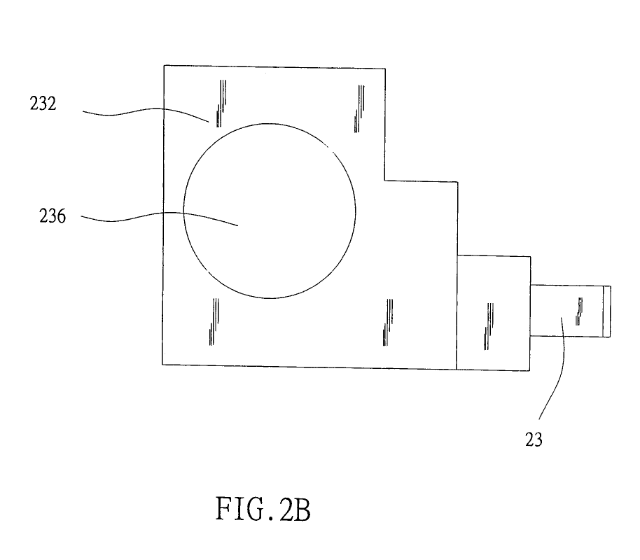

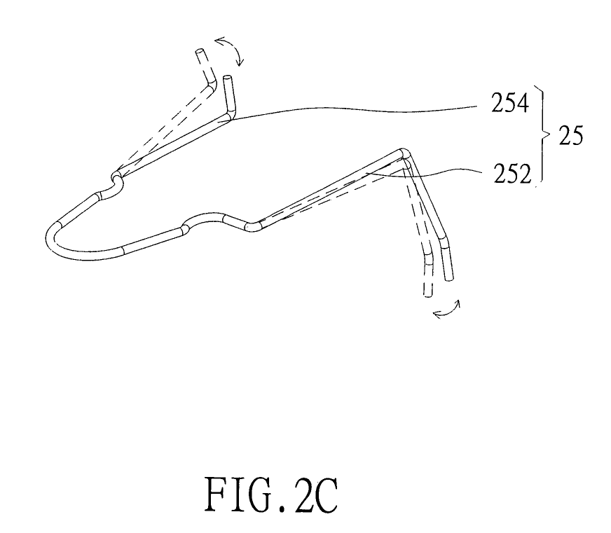

Referring to FIG. 2A, a schematic view of the preferred embodiment of an optical pickup device with elastic member of the present invention in use is shown. An optical pickup device 20 with elastic member 25 of this embodiment mainly comprises a driver 21, a gear 22, a rack 23, an optical head 24 and an elastic member 25. The gear 22 associated with the driver 21 is rotated by it. The driver 21 can be a servomotor and the gear 21 can be a spur gear. The rack 23 is meshed and interlocked with the gear 22. The elastic member 25, made of such as stainless steel or spring steel, is fixed with the optical head 24 and is shored against to the rack 23.

A side view of the preferred embodiment of a first fixed support of the optical pickup device with elastic member of the present invention in use is shown in FIG. 2B. Referring to both FIG. 2A and 2B, the back of rack 23 is associated with two first fixed supports 232 and one end of the optical head 24 has two second fixed supports 242. The clearance between the first fixed supports 232 is larger than the clearance between the second fixed supports 242 and the two second fixed supports 242 are connected tightly with the two first fixed supports 232 respectively. However, being deserve to be mentioned, a guide bar 26 is applied to this embodiment which penetrates a center hole 236 of the connected first fixed support 232 and second fixed support 242 so that the rack 23 and the optical head 24 can slide along the guide bar 26 through the first fixed support 232 and second fixed support 242, i.e. when the gear 22 is driven by the driver 21, the rack 23 and the optical head 24 are driven, too.

FIG. 2C is a schematic view of the preferred embodiment of an elastic member of the optical pickup device with elastic member of the present invention in use. Referring to both FIG. 2A and FIG. 2C, the elastic member 25 of the embodiment, a linear material with bending sharp, has a first sideline 252 and the opposite second sideline 254 and the back of the rack 23 has a protuberance. Being deserved to be mentioned, on the end having the second fixed support 242 of the optical head 24, a first bump 244 and a second bump 246 are also located. The first sideline 252 and second sideline 254 shore against the first bump 244 and the second bump 246 by a locking screw respectively. Thus, the elastic member 25 is locked with the optical head 24 so that the first sideline 252 of the elastic member 25 shores against the back of the rack 23 for providing a vertical elasticity thereto and the second sideline 254 of the elastic member 25 shores against the protuberance 234 of the rack 23 for providing a vertical elasticity thereto. In the moving, the change of elastic of the first sideline 252 and the second sideline 254 ranges between 10 g and 30 g so that the first sideline 252 shoring against the rack 23 gives the vertical elasticity to the rack 23 in the mesh of the gear 22 and the rack 23 and then enables the rack 23 to rotate upward slightly to reduce the back clearance between the gear 22 and the rack 23. Also, the that the second sideline 254 shoring against the protuberance 234 of the rack 23 gives the parallel elasticity to the axle of the rack 23 and reduces the clearance between the rack 23 and the optical head 24 effectively to improve the positioning precision.

To sum up, the optical pickup device 20 with elastic member 25 could be a DVD-ROM drive, a DVD-R drive, a DVD-RW drive, a CD-ROM drive, a CD-R drive or a CD-RW drive.

In the mentioned embodiment, an elastic member applied to the invention is shored against to the rack to provide a vertical elasticity and a parallel elasticity to the rack axle and reduce the clearance between connecting components effectively. It is therefore understood that although the present invention has been specifically disclosed with the preferred embodiment and elastic member that cannot limit the scope of this invention. Modifications to the design concerning methods, such as different elastic member, will be apparent to those skilled in the art and such modifications and variations, such as driving structures other than racks and gears, are considered to be equivalent to and within the scope of the disclosed invention and the appended claims.

Therefore, the optical pickup device with elastic member of the invention provides at least the following advantages:
a. The clearance between the rack and the optical head can be reduced to improve the positioning precision;
b. The back clearance between the gear and the rack can be reduced to improve the positioning precision;
c. The fabrication of the elastic member is simple and easily to be processed. The elasticity can be designed properly and be maintained stably, and
d. The meshing clearance between the vertical and parallel axles of rack can be justified by the elastic member that is convenient to be processed and fabricated to reduce the prime cost.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An optical pickup device with elastic member, said device comprising:
a driver;
a gear, said gear associated with said driver being driven by it;
a rack, said rack meshing with said gear and back of said rack having at least a first fixed support;
an optical head, one end of said optical head having at least a second fixed support;
a guide bar, said guide bar penetrateing said first fixed support and said second fixed support, and
an elastic member, said elastic member associated with said optical head and shoring against said rack to provide a vertical elasticity and a parallel elasticity to an axle of said rack.

2. The device of claim 1, wherein said driver is a servomotor.

3. The device of claim 1, wherein said gear is a spur gear.

4. The device of claim 1, wherein said elastic member is a linear material made of the group consisting of stainless steel and spring steel.

5. The device of claim 1, wherein back of said rack has a protuberance shored against by said elastic member.

6. The device of claim 5, wherein said elastic member has a first sideline and a second sideline connecting together and said first sideline shores against back of said rack to provide the vertical elasticity while said second sideline shores against said protuberance to the parallel elasticity.

7. The device of claim 6, wherein said optical head has a plurality of protuberances which said first sideline and said second sideline shores against respectively through a locking screw and locks said elastic member with said optical head.

8. The device of claim 6, wherein the change of elasticity of said first sideline and said second sideline ranges between 10 g and 30 g.

9. The device of claim 1, wherein said device is chosen from the group consisting of DVD-ROM drive, DVD-R drive, DVD-RW drive, CD-ROM drive, CD-R drive and CD-RW drive.
